(19) United States
(12) Patent Application Publication
(10) Pub. No.: US 2010/0329816 A1
(43) Pub. Date: Dec. 30, 2010

(54) Self-Tapping Insert and Method of Utilizing the Same to Replace Damaged Threads for Hydraulic and Pneumatic Applications

(76) Inventor: Carl Strom, Topanga, CA (US)

Correspondence Address: KLEIN, DENATALE, GOLDNER, COOPER et. al., P.O. BOX 11172, BAKERSFIELD, CA, 93389-1172, US

(21) Appl. No.: 12/882,137

(22) Filed: Sep. 14, 2010

Related U.S. Application Data
(63) Continuation-in-part of application No. 11/982,067, filed on Oct. 31, 2007, now Pat. No. 7,819,613.

(51) Int. Cl. F16B 25/10

(52) U.S. Cl. 411/387.4

(57) ABSTRACT

A self-tapping insert is installed in a pre-existing bore hole in a workpiece by rotating the insert, causing cutting threads on the exterior of the self-tapping insert to cut new threads. Engagement threads on the exterior of the self-tapping insert engage the new threads to retain the self-tapping insert within the workpiece. The self-tapping insert may comprise internal threads which are used to replaced damaged threads in the workpiece. The exterior threads of the self-tapping insert may be configured as left-handed threads, while the internal threads are right-handed threads. The top of the self-tapping insert may comprise an integral hexagonal shape, and a drive socket of corresponding size and shape may be employed to install the self-tapping insert, eliminating the need for installing the insert with a drive bolt, and permitting the left-handed rotation of the self-tapping inserts external threads.

### CROSS-REFERENCE TO RELATED APPLICATION

This is a continuation-in-part application of U.S. application Ser. No. 11/982,067 which was filed on Oct. 31, 2007 to which application this inventor claims domestic priority.

### BACKGROUND OF THE INVENTION

The present invention generally relates to plugs and fittings and threaded workpieces, and securing an effective hydraulic or pneumatic seal when internal threads of the workpiece need to be repaired or replace. The present invention is more particularly directed to affixing an internally threaded insert within a workpiece so that a plug or fitting may be made up to the workpiece utilizing the threads of the insert and while maintaining the required sealing integrity of the installation.

For a variety of reasons it is desirable to dispose a self-tapping sleeve within a workpiece. Most, but not all of the time, the self-tapping sleeve will have internal threads and will be utilized for thread replacement. For example, if pre-existing threads of the workpiece are damaged, the damaged threads may be replaced with the threads of the insert. One type of internally-threaded insert is self-tapping, such that the insert may be driven into a bore of the workpiece, cutting threads in the bore as the insert is driven. The self-tapping inserts have both internal threads for receiving a fastener and external threads. A first group of external threads cuts new threads in the bore, and a second group of external threads makes up into the new threads, thereby advancing and securing the self-tapping insert within the bore and thus providing new threads within the workpiece.

The most common use of self-tapping inserts is to provide replacement threads where the original threads of the workpiece have become damaged, and to stabilize the matrix material to prevent cracks from continuing or propagating. When the original threads become damaged, they can sometimes be repaired by chasing the damaged thread with a tap to restore the original thread shape. However, if the original thread shape cannot be restored by this measure, the thread must be replaced. One means of replacing the threads is to bore the hole to a larger diameter than the original thread diameter and to rethread the hole. However, a disadvantage of this procedure is that it requires a change in the plug or fitting size from the original. If the equipment utilizes multiple plugs or fittings of the original size, the different size plug or fitting complicates maintenance and repair of the equipment because different tools are required, and correlating plugs or fittings with the matching threads made more difficult. It is therefore desirable in some cases to be able to replace the original threads with threads of the same size so that the same size plug or fitting may be utilized. In these cases, self-tapping inserts may be employed.

Self-tapping inserts are hardened steel cylinders, threaded on the exterior and, usually, in the interior. The interior thread diameter and pitch of the internal threads are those of the plug or fitting to be installed. The exterior of the self-tapping insert comprises a section which cuts new threads (the “cutting section”) and a section of threads which make up into the newly cut threads. The cutting section of the known self-tapping inserts is tapered and usually comprises three or more slots or holes, which interrupt the tapered threads, thereby forming teeth similar to those of a conventional thread tap. Typically a bolt (the “drive bolt”) is used to drive the self-tapping insert into a pilot hole in the base metal. This pilot hole is usually made by drilling out the damaged threads as described above to form a bore hole in the base metal. As the insert is turned, the teeth of the cutting section engage and remove the base metal until the insert is fully installed and flush with the exterior surface of the workpiece. The insert remains in place within the workpiece by an interference fit between the newly cut threads in the workpiece and the exterior threads on the insert.

The known self-tapping inserts have several disadvantages. Because the known self-tapping inserts are tapered on the tapping end (i.e., the end which is first inserted into the bore hole), the inserts have a tendency to start tapping crookedly. The person performing the tapping procedure has no simple way other than by visual inspection to ascertain whether the insert is entering the bore hole straight—i.e., whether the longitudinal axis of the insert coincides with the longitudinal axis of the bore hole. The only way to ensure that the prior-art insert enters the bore straight is to utilize a magnetic drill (“mag drill”) which attaches to the work-piece with an electromagnet. An example of such a mag drill is disclosed in U.S. Pat. No. 3,969,036 (Hougen). The procedure requires: (1) positioning the mag drill by means of a centering tool; (2) replacing the centering tool with a drill bit and drilling out the damaged threads; (3) customizing the drive bolt by removing its head so that it can be fitted to the chuck of the mag drill; (4) with the mag drill maintained in exactly the same location as established in step (1), threading the prior art insert onto the modified drive bolt and installing the modified drive bolt into the chuck of the mag drill; (5) driving the prior art insert two to three rotations with the mag drill, until it has started to cut new threads; and (6) completing the installation with a wrench, socket wrench, pneumatic impact wrench, mechanical torque multiplier, or hydraulic torque multiplier, depending upon the torque required to install the prior art insert.

It is important that the insert be installed straight, which means it must be correctly aligned at the initiation of the installation procedure. If the insert is too crooked during installation, the insert may shatter when partially installed because of the hardness of the insert. If the insert is installed crooked and yet does not break or shatter, its misalignment with the smooth bore may cause leaking of pressurized air or liquid between the self-tapping insert's external threads and the walls of the smooth bore. The alignment problem becomes more severe for larger inserts. In recognition of this problem, one manufacturer of self-tapping inserts requires that the installation method for larger diameter inserts (such as larger than ¾ inch) include counter-boring or partially pre-tapping the pilot hole for the insert such that the insert will be properly aligned within the hole. Counter-boring or pre-tapping the pilot holes are demanding, time-consuming and expensive procedures requiring large-diameter drill bits and/or taps, often under difficult field conditions.

When a prior-art self-tapping insert is used to rethread a bore, the insert is driven in a clockwise rotation. As a consequence of this clockwise rotation, the exposed edge (hereinafter the “leading edge”) of an opening in the wall of the insert acts as a cutting edge for cutting the new threads as the leading edge cuts into the wall of the bored hole. The edge on the opposite side of the opening from the leading edge is hereinafter referred to as the “trailing edge”. On the known self-tapping inserts, the leading edge and trailing edge are of equal height. As a consequence of the equal height, metal chips created by the cutting of the new threads are forced into the new threads as the new threads are being created, causing binding and galling. The binding and galling require a very high torque and/or a combination of high torque and impact from heavy-duty pneumatic or hydraulic tools to overcome to properly seat the insert within the hole. As a consequence of the high torque requirement, another disadvantage of the known self-tapping inserts is manifested. The known self-tapping inserts cannot be through-hardened to a hardness of more than 52 RC to 54 RC without a risk of cracking, metal fatigue, etc. resulting from the application of the necessary torque and impact to properly seat the insert because of the galling and binding described above. This limitation on the hardness of known self-tapping inserts prevents use of the inserts in workpieces in which the base metal has a greater hardness, because the inserts are not sufficiently hard to cut threads in the base metal.

The known self-tapping inserts generally rely upon an interference fit between the newly cut threads and the external threads of the insert to prevent the insert from backing out of the base metal. The small metal chips generated by the cutting action of the insert assist the interference fit by wedging between the external threads of the insert and the new threads of the base metal. While this phenomenon is effective in preventing back-out of the insert from the base metal, it increases the torque requirements for installing the insert as described above.

The method of installing the known self-tapping inserts presents another disadvantage. The known self-tapping inserts are installed with a drive bolt having the same diameter and thread pitch as the insert. A nut and/or a combination of a nut and washers are utilized as a spacer between the head of the drive bolt and the insert. This spacer acts as a stop when the insert is inserted to the point that the top side of the insert is flush with the top surface of the workpiece. Because of the high torque levels required to install conventional self-tapping inserts, the drive bolt can seize up within the insert, particularly with the larger diameter inserts, causing the prior art insert to back out of the workpiece upon removal of the drive bolt. This is particularly so for applications in which the self-tapping insert will accommodate a plug or fitting with mating (tapered) threads: For such applications, the installation bolt must itself have matching tapered threads. Such bolts are commercially unavailable, and must be custom manufactured. Yet another related disadvantage of such known self-tapping inserts with tapered threads is that the tapered-thread drive-bolt used to install them is highly likely to mate with the self-tapping insert's internal tapered threads, causing the insert to back out as its installation bolt is removed. The same is true for the removal of any fitting or plug from the existing tapered-thread self tapping insert.

A need therefore exists for a self-tapping insert which satisfies one or more of the following criteria: (1) consistently remains aligned within the workpiece without the need for counter-boring and/or pre-tapping; (2) having a hardness in excess of 54 RC yet capable of being installed without shattering; (3) a reduction in the necessary installation torque; and (4) having an installation method which prevents backing out of the insert from the workpiece because of seizing/galling with the drive bolt during the act of installation, or because the workpiece's installed plug or fitting has itself seized with the insert.

### SUMMARY OF THE INVENTION

The present invention is directed to embodiments of a self-tapping insert which meets one or more of the needs identified above. The disclosed self-tapping insert is utilized to provide new threads within the smooth bore of a workpiece, particularly in hydraulic and pneumatic thread-replacement applications. If the insert is utilized to provide new threads to replace damaged threads, the damaged threads are drilled out to provide the smooth bore.

An embodiment of the disclosed self-tapping threaded insert comprises a cylindrical body having a top, a bottom, an interior portion and an exterior portion, where the cylindrical body defines a central axis. The interior portion of the insert comprises a first set of threads. The exterior portion comprises tapping or cutting threads and engagement threads and a pilot section. In relative order from the bottom of the cylindrical body (i.e., the end of the insert first inserted within the borehole), the exterior portion of the insert comprises a pilot section, a plurality of cutting threads, and a plurality of engagement threads.

The pilot section has a external diameter along its entire length which is sized such that the pilot section penetrates the smooth bore, but the tolerances between the smooth bore and pilot section are close (for example, 0.003″ per side). The diameter of the pilot section defines a plane which is perpendicular to the central axis of the cylindrical body. The pilot section has sufficient length to maintain the central axis of the self-tapping insert in general alignment with the longitudinal axis of the smooth bore, such that the insert is not crooked or out of alignment with the bore.

The cutting threads comprise means for cutting threads in the smooth bore which are used for locking the insert within the bore. The engagement threads thereafter engage the insert locking threads as the insert is made up into the bore. A driving means is required to drive the body of the insert into the bore until the insert is completely seated within the bore.

Embodiments of the apparatus comprise means for cutting threads in the smooth bore. The thread cutting means may comprise one or more apertures in the cylindrical body where the apertures extend from the exterior portion to the interior portion of the insert, where each aperture comprises at the exterior portion a leading edge and a trailing edge. The apertures may be circular, oval, or elongated slots. The “height” (i.e., the radial extension) of the leading edge may be greater than that of the trailing edge. That is, if a first diameter is defined by the rotation of the leading edge about the central axis of the cylindrical body and a second diameter is defined by the rotation of the trailing edge about the central axis, the first diameter would be greater than the second diameter. This feature of the apparatus is referred to as “chip relief”, because it allows the chips generated in the tapping operation to escape easily. This feature is distinct from known self-tapping inserts in which the leading edge and trailing edge have the same height.

Embodiments of the apparatus may further comprise left-handed threads for the cutting threads and the engagement threads. The use of left-handed threads on the exterior portion of the insert prevents the insert from backing out of the work-piece when a plug or fitting is backed out of the insert, which might otherwise occur if the plug or fitting seizes up inside the insert due to galling, corrosion, or the mating action of tapered threads, etc. For this embodiment, the application of counter-clockwise torque to break the plug or fitting free results in the tightening of the insert within the base metal of the workpiece.

Embodiments of the apparatus may comprise driving means which complement the use of left-handed threads for the cutting threads and engagement threads. The top of the insert may comprise a hexagon whose wall extends from the exterior portion to the interior portion of the self-tapping insert, and whose interior embodies the thread type of the plug or fitting to be installed within it. The insert's hexagon top is engaged with a driving tool, such as a socket. It is to be appreciated that the use of the hexagonal drive head and driving tool allows the self-tapping insert to be installed with left-handed rotation, while the inside threads of the insert remain right-handed threads.

Methods of replacing damaged threads utilizing embodiments of the disclosed apparatus generally comprise the steps of drilling out the damaged threads to create a pilot hole. An embodiment of the apparatus having left-handed external threads is inserted into the pilot hole and left-handed rotation of the self-tapping insert is accomplished by means of a socket applied to the insert's hexagonally-shaped drive head.

These and other features, aspects, and advantages of the present invention will become better understood with regard to the following description, appended claims, and accompanying drawings.

### BRIEF DESCRIPTION OF THE DRAWINGS

FIG. 1 is a perspective view of a prior art self-tapping insert.

FIG. 2 is a side view of the prior art self-tapping insert depicted in FIG. 1.

FIG. 3 is a perspective view of the prior art self-tapping insert shown in FIG. 1 attached to a drive bolt and utilizing a nut and washers for spacers.

FIG. 4 is a side view of the prior art self-tapping insert and drive bolt combination shown in FIG. 3.

FIG. 5 schematically shows a prior art self-tapping insert, as ideally disposed within the bore hole of a workpiece prior to the removal of the drive bolt.

FIG. 6 shows an isometric view of an embodiment of the presently disclosed self-tapping insert.

FIG. 7 shows a side view of an embodiment of the presently disclosed self-tapping insert.

FIG. 8 is a sectional view taken along line 8-8 of FIG. 7.

FIG. 9 is an exploded view of an embodiment of the self-tapping insert comprising a removable pilot extension member.

FIG. 10 shows the embodiment of FIG. 9 in an assembled configuration.

FIGS. 11-15 illustrate a procedure for using embodiments of the disclosed invention.

### DETAILED DESCRIPTION OF THE EMBODIMENTS

When the threads of a workpiece cannot be repaired by chasing the damaged thread with a tap to restore the original thread shape, replacement of the threads with a self-tapping insert provides an alternative method of repair. The pilot hole is usually made by drilling out the damaged threads to form a smooth walled bore hole in the base metal, and the prior art insert is placed within the bore hole.

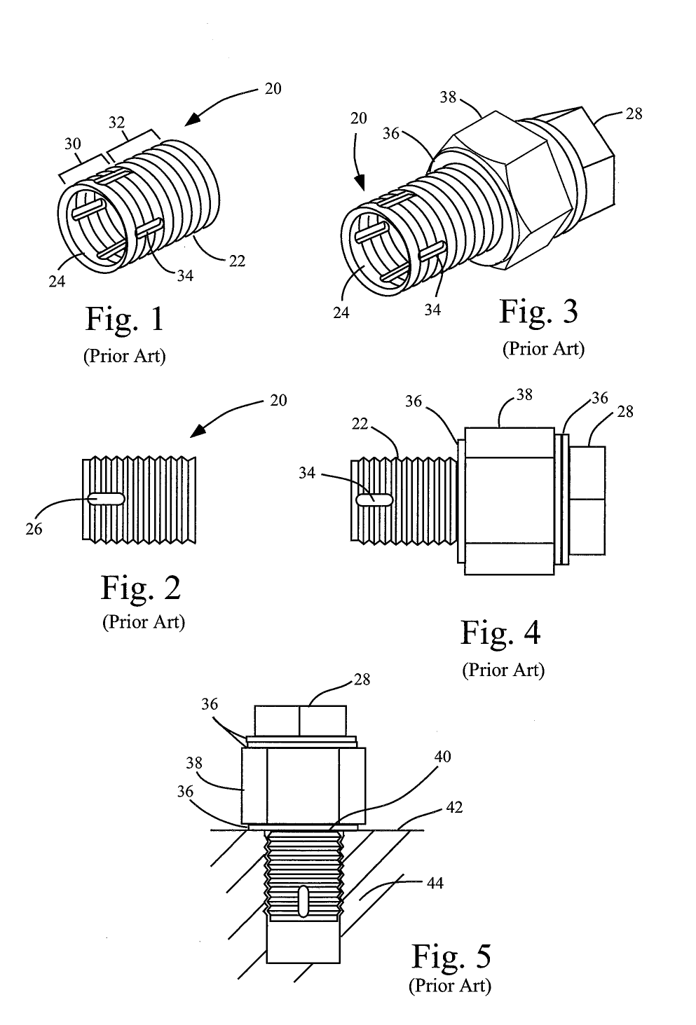

Referring now specifically to the drawings, FIGS. 1 through 4 show a prior art self-tapping insert 20, which is a hardened steel cylinder, threaded on the exterior and interior. The prior art insert 20 comprises external threads 22, internal threads 24 and apertures 26. The prior art self-tapping insert 20 is generally installed with drive bolt 28 which makes up into internal threads 24 of the insert. The diameter and pitch of interior threads 24 are those of the fastener to be installed. The exterior of the self-tapping insert 20 comprises a first section 30 which cuts new threads (the “cutting section”) and a second section 32 which comprises threads which make up into the newly cut threads.

Drive bolt 28 is used to drive the prior art self-tapping insert 20 into a pilot hole in the workpiece 44 as schematically shown in FIG. 5. The cutting section 30 of the known self-tapping inserts is tapered and usually comprises three or more apertures 26 which interrupt the tapered threads. As the drive bolt 28 is rotated clock-wise (turned right-handed), the leading edges 34 of the apertures 26 engage and remove the base metal until the insert is fully installed and flush with the top surface 42 of the workpiece 44. Referring to FIG. 3, the term “leading edge” is defined as the edge of the aperture 26 which, as the insert 20 is rotated clock-wise, is the cutting edge.

The insert remains in place within the workpiece 44 by an interference fit between the newly cut threads in the workpiece and the threads of the second section 32 of the insert 20. Spacers, such as washers 36 or nut 38 are utilized to allow the top of the prior art insert 20, once installed, to be flush with the top surface 42 of the workpiece. It is to be appreciated that FIG. 5 depicts the ideal installation of a prior art self-tapping insert 20 into a workpiece 44, i.e., where the insert is straight with respect to the borehole such that the longitudinal axis of the insert is generally aligned with the axis of the bore hole.

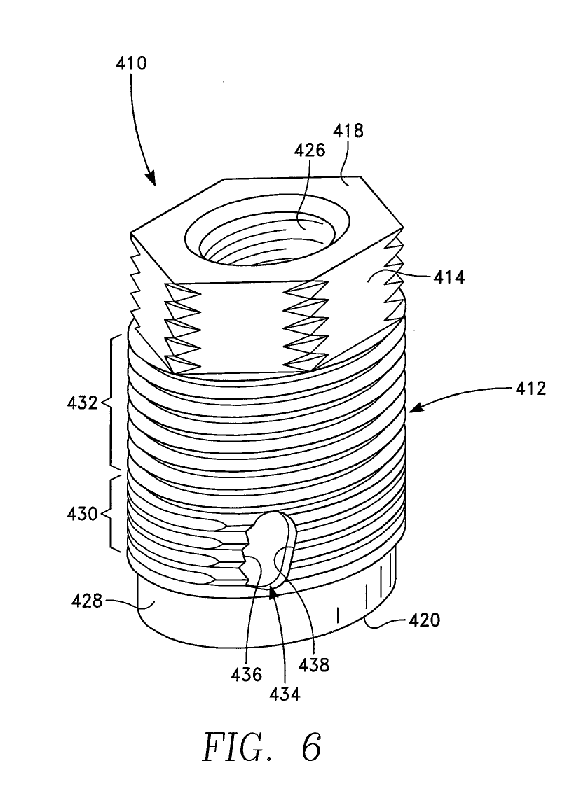

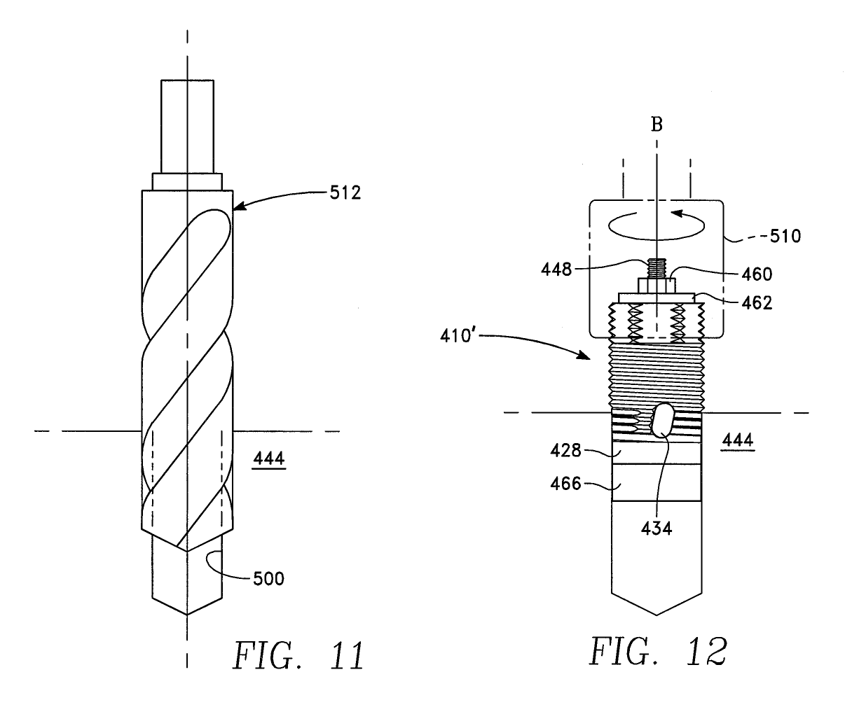

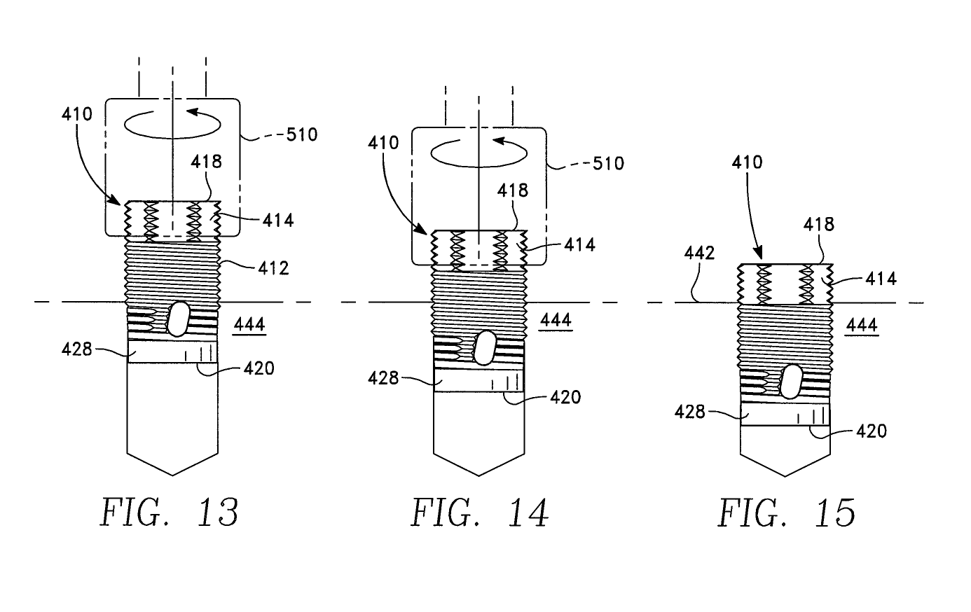

FIGS. 6 through 15 show an embodiment of the disclosed self-tapping insert 410. This embodiment comprises a cylindrical body 412. The components of the disclosed self-tapping insert 410 may be fabricated from various materials having the requisite mechanical properties based upon the material of the workpiece. Suitable materials comprise steel and various alloy steels. The hardness of self-tapping insert 410 will be higher than the hardness of the base material. As discussed above, various features of embodiments of the disclosed apparatus, and the methods for installing the apparatus, allow the use of harder metals for the self-tapping insert, because the torque required to install the disclosed self-tapping insert is not as high as for the known self-tapping inserts. Instead of being limited to hardness values of approximately 54 RC, the disclosed self-tapping insert have a greater hardness value because of the reduced risk of shattering during installation.

Cylindrical body 412 has a top 418 which will, in most applications for hydraulic and pneumatic fittings, be set above top surface 442 of the work piece 444. Cylindrical body 412 further comprises a bottom 420 which is the end first inserted into the pilot hole, unless a pilot extension member 428 is utilized at the beginning of the installation procedure. Cylindrical body 412 is configured to have an interior portion which comprises all surfaces and structures on the inside of the cylindrical body, which includes a first set of interior threads 426. If the threads are utilized for connecting a plug or fitting, interior threads 426 may be tapered threads, or may generally be of all thread types, including USS, UNC, SAE, metric, standard pipe thread, metric pipe thread, British Special Pipe, Acme, etc. The interior portion may further comprise a smooth bore section which axially extends approximately from apertures 434 to bottom 420, such that the interior threads extend from approximately top 418 to the apertures 434, and the smooth bore section may have a smaller inside diameter than the threaded portion. This configuration provides sufficient tapered threads for creating a sealing connection with the threads of a plug or fixture while also providing for a thicker wall at the portion of the insert internally adjacent to the cutting threads 430.

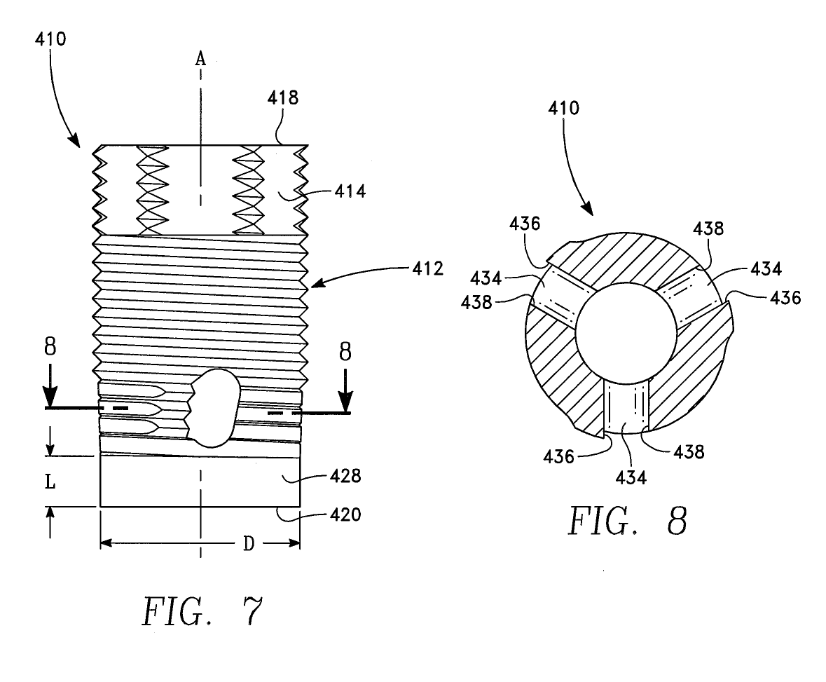

Cylindrical body 412 also has an exterior portion which term refers to all surfaces and structures on the exterior of the cylindrical body. As shown on FIG. 7, the cylindrical body 412 defines a central axis A. The exterior portion comprises, in relative order from the bottom 420 of the cylindrical body 412, a pilot section 428, a plurality of cutting threads 430, and a plurality of engagement threads 432.

Pilot section 428 has a diameter D and a first length L as shown in FIG. 7. A plane is defined by the diameter D of the pilot section 428 which is perpendicular to the central axis A of the cylindrical body 412. Diameter D is sized to penetrate the smooth bore of the pilot hole 500, which is usually made by drilling out damaged threads. First length L is configured to maintain the central axis A of the self-tapping insert 410 in general alignment with the longitudinal axis B of the smooth bore into which the self-tapping insert is installed. Pilot section 428 may have a constant diameter D along its entire length. Diameter D is sized such that the pilot section 428 penetrates the smooth bore, but the tolerances between the smooth bore and pilot section are relatively close. For example the tolerance between the internal diameter of the smooth bore and diameter D may range from 0.003 to 0.006 inches per side. For example, if a pilot hole is drilled with a 1 7/16 inch drill bit, creating a pilot hole having an internal diameter of approximately 1.4375 inches, diameter D of pilot section 428 may be 1.432 inches, leaving a total tolerance of 5.5 thousandths of an inch, or slightly less than 3 thousandths per side.

Cylindrical body 412 comprises a plurality of apertures 434 which extend from the exterior portion to the interior portion of the self-tapping insert 410, where each aperture 434 comprises an opening on the exterior portion. The side of the apertures 434 on the exterior portion are bounded on opposing sides of the aperture by a leading edge 436 and a trailing edge 438. The self-tapping insert 410 may comprise left-handed cutting threads 430 and left-handed engagement threads 432 on the exterior portion. An embodiment of the self tapping insert may be installed by rotating the self-tapping insert 410 counter-clockwise, as indicated on FIG. 12, with an installation tool, as a hex head driver 510. As the self-tapping insert is rotated, leading edge 436 will tap new threads as it progresses through the smooth bore. As the new threads are cut, metal chips or strips will be cut from the smooth bore, some of which will be gathered into the interior portion of the cylindrical body 412 through apertures 434. The axis of apertures 434 may be normal to the wall of the cylindrical body, such that the axis of the aperture coincides with a radius of the cylindrical body 412. Alternatively, to assist in directing metal chips to the interior portion 422, the axis of the apertures 434 may be offset from the radius by a small amount, such as fifteen degrees.

In the prior art insert 20, the leading edge 34 is the same radial distance from the center of the insert as the trailing edge, i.e., the opposing side of the aperture. As a result, chips cut by the rotation of the leading edge against the interior wall of the bore hole tend to be driven into the newly cut threads, thereby causing binding and galling of the threads and increasing the torque required to properly seat the insert into the bore hole.

In contrast, an embodiment of the disclosed self-tapping insert 410 comprises a leading edge 436 which has a greater radial distance from the center of the insert than the trailing edge 438. The “height” (i.e., the radial extension) of the leading edge may be greater than that of the trailing edge. In other words, if a first diameter is defined by the rotation of the leading edge 436 about the central axis A and a second diameter is defined by the rotation of the trailing edge 438 about the central axis, the first diameter will be greater than the second diameter. This feature is best shown in FIG. 8, which shows the difference in radial extension between the leading edge 436 and the trailing edge 438.

This feature, known as “chip relief”, serves to direct chips to the interior portion of the insert rather than forcing chips into the newly cut threads. The resulting reduction of galling and binding reduces the torque required to seat the insert into the bore hole.

The self-tapping insert 410 further comprises driving means for applying the required rotary motion to the insert to install it in the work piece 444. The driving means may comprise a hexagonal extension 414 which is placed in the top of the exterior portion of the cylindrical body 412, as best shown in FIGS. 6, 9-10. The hexagonal extension is sufficiently long to allow the engagement of the cylindrical body 412 by placement of a socket 510 or opened ended box wrench, or other rotation means. Utilizing the combination of the hexagonal extension 414 and the socket 510 to rotate the self-tapping insert 410 facilitates the use of left-handed threads on the exterior portion of the insert while having right-handed threads for the interior threads 426.

Embodiments of the disclosed apparatus may be utilized in various methods for replacing damaged threads utilized by fittings, plugs and similar devices. A first method generally comprise the steps of drilling out the damaged threads with drill bit 512 to create a pilot hole 500 in the work piece 444. Once the pilot hole 500 has been installed, an embodiment of the apparatus is inserted into the pilot hole and rotation of the self-tapping insert is accomplished by means of a wrench 510, socket, or other rotation means applied to the cylindrical body 412, such as to the hexagonal extension 414.

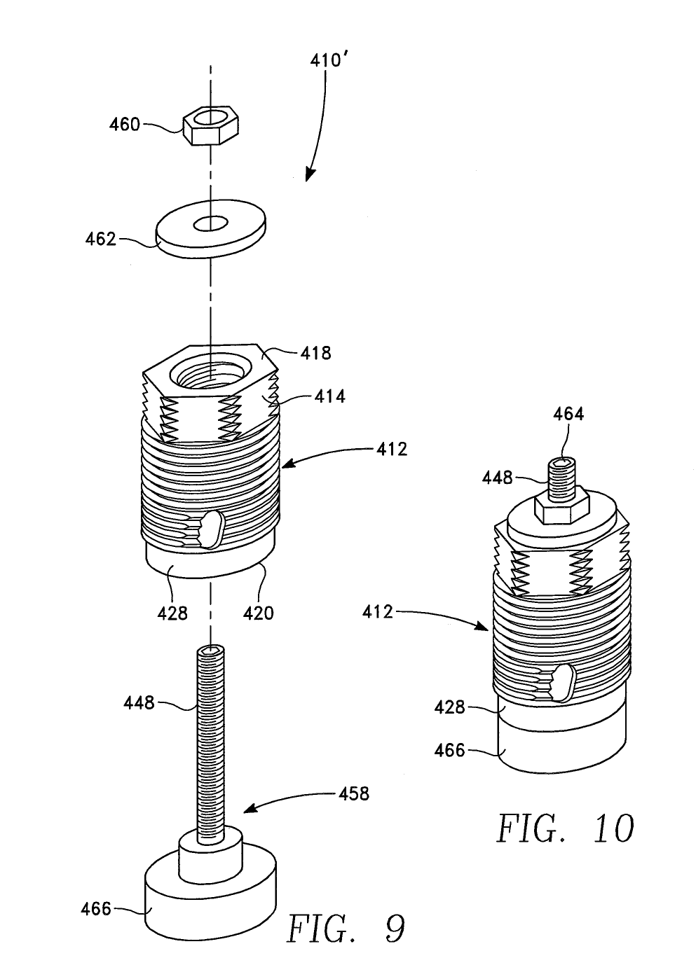

FIGS. 9-10 respectively show exploded and assembled views of an embodiment of the apparatus which further comprises a pilot section extension member 458 which is removeably attached to the device, such as to an axially-aligned threaded fastener 448 which may extend through the cylindrical body 412 and be retained at the top 418 of the cylindrical body by a combination of a nut 460 and washer 462. As shown in FIG. 10, the top of fastener 448 may comprise an axially-aligned hexagonal aperture 464 which may be utilized for insertion of an Allen key to prevent rotation of the fastener 448 as nut 460 is made up or loosened. The pilot extension member 458 comprises a large diameter section 466 which has approximately the same outside diameter as the pilot section 428. When the pilot extension member 458 is attached to this embodiment of the self-tapping insert 410′, it increases the effective length of the pilot section 428. This increase in effective length allows greater penetration of the device within the pilot hole 500, thereby reducing the angle of deflection between the longitudinal axis of the smooth bore B and the central axis of the self-tapping insert A.

The pilot extension member 428 may be utilized in cases in which the tolerances between the smooth bore and the pilot section are so large as to allow excessive play between the smooth bore and the pilot section, which may, without the pilot extension member, result in a misaligned self-tapping insert. When the pilot extension member 458 is utilized, the whole apparatus, including the pilot extension member 458, is placed within the bore hole. The self-tapping insert 410′ is then rotated several turns to cut new threads. The apparatus is thereafter removed from the bore hole and the pilot extension member 458 is removed from the apparatus. The self-tapping insert 410 is thereafter rotated into the new threads, and further rotated with socket 510 to complete the cutting of the threads and to set insert as described above. The pilot extension member 458 allows several threads to be cut with the self-tapping insert 410′ which are sufficient to axially align the insert with the bore hole. Once a few threads are cut and the extension member removed, the self-tapping insert 410 (with pilot extension member 458 removed) is screwed into the newly cut threads in the top of the borehole, which maintain the insert in axial alignment for the completion of the installation.

These and other features, aspects, and advantages of the present invention will become better understood with regard to the following description, appended claims, and accompanying drawings. While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A self-tapping insert for disposing within a smooth bore, the smooth bore comprising a longitudinal axis, said self-tapping insert comprising:
a cylindrical body having a top, a bottom, an interior portion and an exterior portion, the cylindrical body defining a central axis;
the interior portion comprising a first set of threads;
the exterior portion comprising, in relative order from the bottom of the cylindrical body, a pilot section, a plurality of cutting threads, the cutting threads comprising a leading edge and a trailing edge for cutting insert locking threads in the smooth bore, and a plurality of engagement threads, the engagement threads sized to engage the insert locking threads;
the pilot section having a generally smooth outer surface with a diameter and a first length, the diameter sized to penetrate the smooth bore and the first length configured to maintain the central axis of the self-tapping insert in alignment with the longitudinal axis of the smooth bore; and
driving means for driving the cylindrical body into the smooth bore.

2. The self-tapping insert of claim 1 wherein the driving means comprises a hexagonal extension of the top of the exterior portion of the cylindrical body.

3. The self-tapping insert of claim 1 wherein a plane generally perpendicular to the central axis is defined by the diameter of the pilot section.

4. The self-tapping insert of claim 1 wherein the tolerance between the pilot section and the smooth bore is less than six-thousandths of an inch per side.

5. The self-tapping insert of claim 1 wherein the diameter of the pilot section is substantially uniform along the first length.

6. The self-tapping insert of claim 1 wherein the cylindrical body comprises a plurality of apertures extending from the exterior portion to the interior portion, wherein each aperture comprises an opening on the exterior portion wherein each opening is bounded on opposing sides by the leading edge and the trailing edge.

7. The self-tapping insert of claim 6 wherein a first diameter is defined by the rotation of the leading edge about the central axis and a second diameter is defined by the rotation of the trailing edge about the central axis, and the first diameter is greater than the second diameter.

8. The self-tapping insert of claim 1 wherein the cutting threads and the plurality of engagement threads are left-handed threads.

9. The self-tapping insert of claim 1 further comprising a removable pilot section extension member.

10. The self-tapping insert of claim 9 wherein the removable pilot section extension member is attached to the cylindrical body by an axially-aligned fastener extending through the top of the cylindrical body and secured by a nut.

11. The self-tapping insert of claim of claim 9 wherein the pilot extension member comprises a large diameter section having the same approximate diameter as the pilot section.

12. The self-tapping insert of claim 10 wherein the axially-aligned fastener is retained at the top of the cylindrical body by a nut and washer combination in which the washer abuts the top of the cylindrical body and the nut is made up onto a portion of the axially-aligned fastener protruding through the nut.

13. The self-tapping insert of claim 12 therein the fastener has a first end centrally attached to the removable pilot section extension member and the fastener has a second end made up into the nut at the top of the cylindrical body.

14. The self-tapping insert of claim 13 wherein the second end comprises an axially-aligned hexagonal aperture.

15. A method of replacing damaged threads in a workpiece utilizing the self-tapping insert of claim 1 comprising the steps of:
drilling through the damaged threads to form a pilot hole;
inserting the self-tapping insert of claim 3 into the pilot hole;
attaching rotation means to the self-tapping insert; and
applying rotation to the self-tapping insert by rotating the rotation means, thereby driving the insert into the pilot hole until the insert is fully seated within the workpiece.

16. The method of claim 15 wherein the cutting threads and the plurality of engagement threads are left-handed threads and the rotation applied to the self-tapping insert is counter-clockwise rotation.

17. The method of claim 15 wherein the driving means comprises a hexagonal extension of the top of the exterior portion of the cylindrical body

18. A method of replacing damaged threads in a workpiece comprising the steps of:
drilling through the damaged threads to form a pilot hole, the pilot hole having a longitudinal axis;
inserting a self-tapping insert into the pilot hole, wherein the self-tapping insert comprises a cylindrical body having an interior portion and an exterior portion, a top and a bottom, the interior portion comprising a first set of threads and the exterior portion comprising, in relative order from the bottom of the cylindrical body, a pilot section, a plurality of cutting threads, a plurality of engagement threads, the pilot section having a diameter and a first length, the diameter sized to penetrate the pilot hole and the first length configured to maintain the central axis of the self-tapping insert in alignment with the longitudinal axis of the pilot hole, and driving means for driving the cylindrical body into the pilot hole, the self-tapping insert further comprising a removable pilot section extension member axially extending from the bottom of the cylindrical bottom;
attaching rotation means to the self-tapping insert;
applying rotation to the self-tapping insert by rotating the driving head, thereby driving the insert into the pilot hole until two to three replacement threads are cut in the pilot hole;
withdrawing the self-tapping insert from the pilot hole;
removing the removable pilot section extension member from the self-tapping insert;
reinserting the self-tapping insert into the pilot hole; and
applying rotation to the self-tapping insert by rotating the rotation means, thereby driving the insert into the pilot hole until the insert is fully seated within the workpiece.

19. The method of claim 18 wherein the driving means comprises a hexagonal extension of the top of the exterior portion of the cylindrical body

20. The method of claim 18 wherein the cutting threads and the plurality of engagement threads are left-handed threads and the rotation applied to the self-tapping insert is counter-clockwise rotation.
